(19) United States
(12) Patent Application Publication
(10) Pub. No.: US 2013/0268210 A1
(43) Pub. Date: Oct. 10, 2013

(54) METHODS AND SYSTEMS FOR PERFORMING AN ELEMENTAL ANALYSIS

(71) Applicant: John I.H. Patterson, Hamilton Square, NJ (US)

(72) Inventor: John I.H. Patterson, Hamilton Square, NJ (US)

(21) Appl. No.: 13/440,755

(22) Filed: Apr. 5, 2012

(51) Int. Cl. G01N 23/223; G06F 19/00

(52) U.S. Cl. 702/28; 378/45

(57) ABSTRACT

A spectrometer for determining a composition of a sample is described. The spectrometer includes a radiation source, a detector, and a processing device coupled to the radiation source and the detector. The radiation source is configured to generate a primary beam of radiation to be directed toward the sample. The detector is configured to generate a detector signal representative of a secondary beam of radiation from the sample after being impinged by the primary beam of radiation. The processing device is configured to control operation of the spectrometer in connection with performing a first elemental analysis of the sample. The processing device is also configured to determine an alloy grade of the sample based on the detector signal generated in connection with the first elemental analysis. Furthermore, the processing device is configured to determine at least one measurement condition based at least partially on the alloy grade.

### BACKGROUND OF THE INVENTION

The embodiments described herein relate generally to X-ray fluorescence (XRF) spectrometry, and more specifically to determining measurement conditions to be applied by an XRF spectrometer.

XRF is the emission of characteristic (also referred to as secondary fluorescent) X-rays from a material that has been excited by, for example, high-energy X-rays, gamma rays, an electron beam, or a radioactive source directed at the material. One specific use of XRF is chemical analysis of a liquid or a solid sample.

An XRF spectrometer is used to examine the composition of the sample. X-rays are usually irradiated onto a surface of the sample, and the X-ray fluorescence radiation emitted by the sample is detected, the energy distribution of the emitted radiation being characteristic of the elements present in the sample, while the intensity distribution gives information about the relative abundance of the sample components. By means of a spectrum obtained in this manner, an expert typically is able to determine the components and quantitative proportions of the examined test sample.

Measurement conditions are typically determined by an operator of the XRF spectrometer. These measurement conditions may include a length of time the measurement is taken, the level of voltage applied to an X-ray generator included within the XRF spectrometer, the filter used, and/or other measurement conditions that may affect the measurement. The recommended measurement conditions depend on the composition of the sample, which may not be known before the element analysis is performed. Furthermore, recommended measurement conditions may depend on the concentration of the elements included in the sample, which also may not be known before the element analysis is performed.

Therefore, the operator of the XRF spectrometer may not know prior to performing the element analysis what measurement conditions will facilitate an efficient element analysis (i.e., an accurate determination of the elemental composition in a minimum amount of time) and determination of the alloy grade.

Accordingly, it is desirable to have an XRF spectrometer that addresses the disadvantages of the known systems described above.

### BRIEF DESCRIPTION OF THE INVENTION

In one embodiment, a spectrometer for determining a composition of a sample is provided. The spectrometer includes a radiation source, a detector, and a processing device coupled to the radiation source and the detector. The radiation source is configured to generate a primary beam of radiation to be directed toward the sample. The detector is configured to generate a detector signal representative of a secondary beam of radiation from the sample after being impinged by the primary beam of radiation. The processing device is configured to control operation of the spectrometer in connection with performing a first elemental analysis of the sample. The processing device is also configured to determine an alloy grade of the sample based on the detector signal generated in connection with the first elemental analysis. Furthermore, the processing device is configured to determine at least one measurement condition based at least partially on the alloy grade.

In another embodiment, a method for determining measurement conditions to be applied by a spectrometer is provided. The method includes performing a first elemental analysis of a sample using a first set of predefined measurement conditions and determining an alloy grade of the sample based on the first elemental analysis. The method also includes determining a second set of measurement conditions based at least partially on the alloy grade.

In yet another embodiment, a control system for use with a spectrometer is provided. The control system includes a memory device configured to store a plurality of measurement conditions and a processing device coupled to the memory device. The processing device is configured control operation of the spectrometer, in accordance with a first measurement condition of the plurality of measurement conditions, to perform a first elemental analysis of a sample. The processing device is also configured to determine an alloy grade of the sample based on the first elemental analysis of the sample and determine a second measurement condition of the plurality of measurement conditions that is associated with the alloy grade. The processing device is also configured to control operation of the spectrometer, in accordance with the second measurement condition, to perform a second elemental analysis of the sample.

In yet another embodiment, a method for configuring a spectrometer to determine an alloy grade of a sample is provided. The spectrometer includes a radiation source, a detector, and a memory device, each communicatively coupled to a processing device. The method includes storing, in the memory device, alloy grade information for each of a plurality of alloy grades. The method also includes storing, in the memory device, at least one measurement condition associated with each of the plurality of alloy grades. The method also includes configuring the processing device to operate the spectrometer in accordance with a first measurement condition to perform a first elemental analysis of the sample. The method also includes configuring the processing device to determine an alloy grade of the sample based on the first elemental analysis and the stored alloy grade information. The method also includes configuring the processing device to determine a second measurement condition based at least partially on the alloy grade, and configuring the processing device to operate the spectrometer in accordance with the second measurement condition to perform a second elemental analysis of the sample.

### BRIEF DESCRIPTION OF THE DRAWINGS

FIG. 1 is a functional block diagram of an exemplary detection system.

FIG. 2 is a perspective view of an exemplary embodiment of the detection system shown in FIG. 1.

FIG. 3 is a flow chart of an exemplary method for determining measurement conditions to be applied by the detection system shown in FIG. 1.

FIG. 4 is a flow chart of an exemplary method for performing an elemental analysis using the detection system shown in FIG. 1.

### DETAILED DESCRIPTION OF THE INVENTION

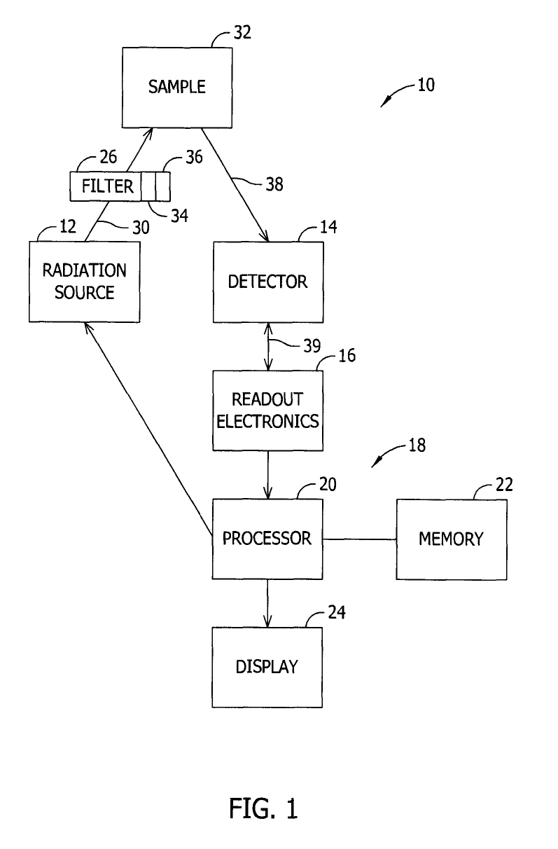

FIG. 1 is a block diagram of an exemplary detection system 10. In the illustrated embodiment, detection system 10 is a spectrometer, and more specifically, an X-ray fluorescence (XRF) spectrometer. In the exemplary embodiment, spectrometer 10 includes a primary beam source 12, a detector 14, readout electronics 16, and a control system 18. In the exemplary embodiment, control system 18 includes a processing device 20 and a memory device 22. Spectrometer 10 may also include a display 24 and/or a filter 26.

The term processing device, as used herein, refers to central processing units, microprocessors, microcontrollers, reduced instruction set circuits (RISC), application specific integrated circuits (ASIC), logic circuits, and any other circuit or processor capable of executing the functions described herein.

It should be noted that embodiments of the invention are not limited to any particular processor for performing the processing tasks of the invention. The term “processing device,” as that term is used herein, is intended to denote any machine capable of performing the calculations, or computations, necessary to perform the tasks of the invention. The term “processing device” also is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of embodiments of the invention, as will be understood by those skilled in the art.

Moreover, aspects of the invention transform a general-purpose computer into a special-purpose computing device when configured to execute the instructions described herein.

In the exemplary embodiment, primary beam source 12 is a radiation source that projects a primary beam of radiation toward a sample material 32 that is selected to be analyzed. For example, primary beam source 12 may include an X-ray tube that projects a primary beam of X-rays 30 toward sample 32. In an alternative embodiment, primary beam source 12 is a radioactive isotope, which projects a primary beam of gamma rays toward sample 32. In yet another alternative embodiment, primary beam source 12 is an electron beam source that projects a primary beam of electrons towards the sample 32. Any suitable beam source, or plurality of sources, known in the art can be used as primary beam source 12.

In the exemplary embodiment, filter 26 is positioned between primary beam source 12 and sample 32. For example, filter 26 may be a selectable filter coupled to processing device 20. Processing device 20 may be configured to select one or more of a plurality of filters that may be applied by filter 26. Processing device 20 may also be configured to select that no filter be applied to primary beam 30. More specifically, filter 26 may include a first filter 34 that modifies characteristics of primary beam 30 in a first manner and a second filter 36 that modifies characteristics of primary beam 30 in a second manner. Examples of materials included within first filter 34 and/or second filter 36 include, but are not limited to, copper, aluminum, and titanium. Although described as including two filters, filter 26 may include any number of filters that allows spectrometer 10 to function as described herein.

Sample 32 becomes excited after being exposed to primary beam 30. This excitation causes sample 32 to emit a secondary (i.e. characteristic fluorescent) radiation 38. Secondary radiation 38 is impinged upon detector 14. Detector 14 converts the secondary radiation to a detector signal 39, for example, a voltage signal or an electronic signal that is representative of the secondary radiation. Detector 14 provides detector signal 39 to readout electronics 16, which determine an energy spectrum of the collected secondary radiation 38. Readout electronics 16 provide this energy spectrum to processing device 20. Although described herein as detector 14 providing detector signal 39 to readout electronics and readout electronics 16 providing the energy spectrum to processing device 20, it is contemplated that readout electronics 16 and/or processing device 20 may take action to receive detector signal 39 and/or the energy spectrum (e.g., may perform polling or a retrieve function in order to receive the signal and/or spectrum). Processing device 20 determines the unique elemental composition of the sample. Processing device 20 may also be referred to as an analyzer and may include a digital pulse processor.

Display 24 allows an operator to view results provided to display 24 by processing device 20, for example, an operator may view the energy spectrum or a derived elemental composition and a final analytical result, such as an alloy identification of sample 32. Display 24 may be built into a handheld enclosure or it may be in the form of a small handheld computer or personal digital assistant (PDA) that is communicatively coupled to processing device 20.

In the exemplary embodiment, spectrometer 10 determines measurement conditions to be applied during an analysis of a sample, for example, sample 32. As described above, processing device 20 controls operation of spectrometer 10, and more specifically, controls operation of radiation source 12. In the exemplary embodiment, processing device 20 operates radiation source 12 in accordance with at least one predefined measurement condition to perform a first elemental analysis of sample 32. For example, processing device 20 may be configured to operate radiation source 12 in accordance with a first measurement condition or a first set of measurement conditions. The measurement condition includes, but is not limited to, a length of time the measurement is taken, a level of voltage applied to radiation source 12, a level of current applied to radiation source 12, and/or a type of filter used. In the exemplary embodiment, a first predefined level of voltage is applied to radiation source 12 for a first predefined length of time to perform the first elemental analysis of sample 32. The first elemental analysis may also be referred to as an initial analysis of sample 32 that provides an initial determination of an alloy grade of sample 32. The first elemental analysis is not stringent enough to determine, to a predefined level of certainty, that sample 32 is composed of the initial determination of the alloy grade. The first set of measurement conditions may be stored in a memory device, for example, memory device 22. In a specific example, an aluminum/titanium (Al/Ti) filter is positioned between sample 32 and detector 14, and power having 40 kV and 10 microamps is applied to radiation source 12 for five seconds.

In the exemplary embodiment, processing device 20 determines the alloy grade of sample 32 based on secondary radiation 38 detected by detector 14. An alloy is a material composed of two or more elements and an alloy grade is an identifier (e.g., a combination of numbers and/or letters) assigned to a material having a predefined combination of elements and concentration of those elements (i.e., an elemental composition of the sample). The elemental composition may also be referred to as an alloy definition. For example, the American Society for Testing and Materials (ASTM) develops and publishes technical standards for alloys. Examples of alloy grades include alloy 303, alloy 304, and alloy 321, which are known types of stainless steel. The technical standards include the elements, and the concentration of those elements, that must be present in a material to be referred to as, for example, alloy 303. The technical standards can be used to differentiate between, for example, alloy 303 and alloy 321. An alloy grade may also be referenced by a Unified Numbering System for Metals and Alloys (UNS) number. Furthermore, the alloy grade referred to herein may be any identifier used to identify a material having a specific elemental composition.

In the exemplary embodiment, memory device 22 also stores alloy grade information. For example, the alloy grade information may include a plurality of alloy grades and associated elemental compositions. In the exemplary embodiment, processing device 20 determines the elemental composition of sample 32 and determines the alloy grade of sample 32 by accessing the alloy grade information stored in memory device 22. In the exemplary embodiment, memory device 22 also stores at least one measurement condition for each of the stored alloy grades. The measurement conditions are predetermined conditions that, if performed, will adequately distinguish between the alloy grades stored within memory device 22. For example, the measurement conditions associated with alloy 303, if performed, will allow spectrometer 40 to identify sample 32 as alloy 303 to a predefined level of certainty. Some measurement conditions are better suited for identifying certain elements than others. For example, elements are more accurately identified when the excitation conditions used during the test substantially match the emission energy of the element of interest. More specifically, heavy elements, which emit high energy X-rays (e.g., Titanium (Ti) to Uranium (U)), are more accurately identified by a stronger primary beam of radiation 30. In contrast, light elements, which emit lower energy X-rays (e.g., Magnesium (Mg) to Scandium (Sc)), are more accurately identified by a weaker primary beam of radiation 30.

Furthermore, there are benefits to completing an elemental analysis quickly, however, a longer testing time is needed to identify some elements and/or concentrations of elements than others. For example, a longer measurement time is needed when very low concentrations define the difference between two alloys. Moreover, a longer measurement time is needed to identify Aluminum (Al) than is needed to identify Ti. Based on the alloy grade, processing device 20 determines a second measurement condition to be applied to perform the second elemental analysis. For example, processing device 20 may be configured to operate radiation source 12 in accordance with a second measurement condition or a second set of measurement conditions. In the exemplary embodiment, once processing device 20 determines the alloy grade of sample 32, processing device 20 accesses the corresponding measurement conditions, which are stored in memory device 22.

In the exemplary embodiment, processing device 20 operates radiation source 12 in accordance with the second measurement condition (i.e., the measurement conditions associated with the alloy grade determined based on the first elemental analysis of sample 32) to perform the second elemental analysis of sample 32. By applying the second measurement condition, spectrometer 40 is able to determine the elements, and concentration of elements, within sample 32 at a predefined level of accuracy. For example, the level of accuracy is predefined such that an alloy grade can be determined to a level of certainty acceptable to the operator, based on the elemental composition determined by the second elemental analysis.

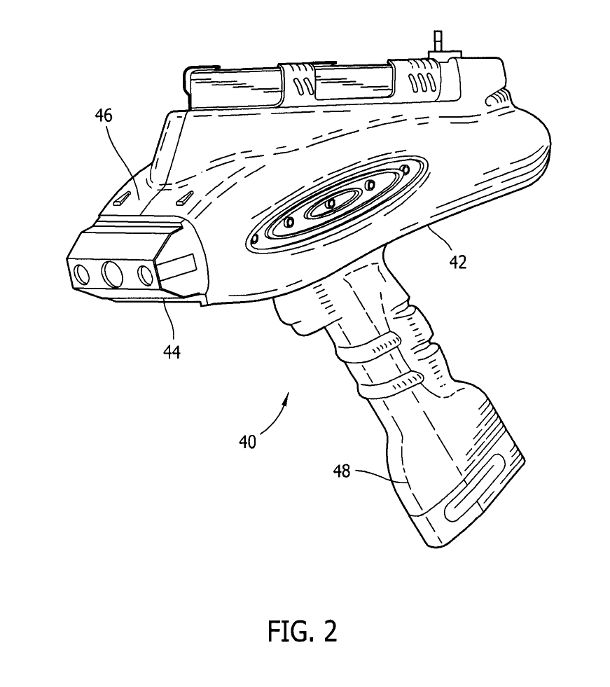

FIG. 2 is perspective view of an exemplary handheld XRF spectrometer 40. Handheld XRF spectrometer 40 is an example of spectrometer 10 (shown in FIG. 1), where components of spectrometer 10 are included within a housing 42 and sized such that a typical operator can lift and carry the spectrometer. Housing 42 encloses and protects the internal assemblies of handheld XRF spectrometer 40. While described herein with respect to handheld XRF spectrometer 40, the methods and systems described herein are also applicable to any other type of spectrometer, including, but not limited to, full-sized and/or tabletop spectrometers.

Housing 42 of handheld XRF spectrometer 40 includes a nosepiece 44 and a body 46. In an exemplary embodiment, housing 42 may have a “handgun-shaped” profile, with a handle 48, extending from body 46. Handle 48 may be positioned such that the user may comfortably hold handle 48 and direct nosepiece 44 to a desired position. Handheld XRF spectrometer 40 includes components similar to those described with respect to FIG. 1, including a detector, a primary beam source, and an analyzer.

In an exemplary embodiment, housing 42 may be composed of one, or a combination of the following: ABS plastics, and alloy materials such as Magnesium, Titanium, and Aluminum. Housing 42 may be composed of any material with the strength to encase and protect the internal components of handheld XRF spectrometer 40. This protection may include, but is not limited to, protection from elements such as wind and rain, protection from dust and other impurities, and protection from damage caused by dropping spectrometer 40 onto a surface or from rough handling of spectrometer 40. This protection may also be bolstered through the use of over molding, rubber bumpers, shock absorbing mounts internal to the instrument assembly, the use of crushable impact guards, and/or any other suitable protective materials.

In one embodiment, housing 42 is composed of lightweight materials, as when in use, handheld XRF spectrometer 40 is held by one of an operator's hands. A light weight handheld XRF spectrometer 40 increases maneuverability and increases the ease-of-use of handheld XRF spectrometer 40 over a heaver handheld spectrometer.

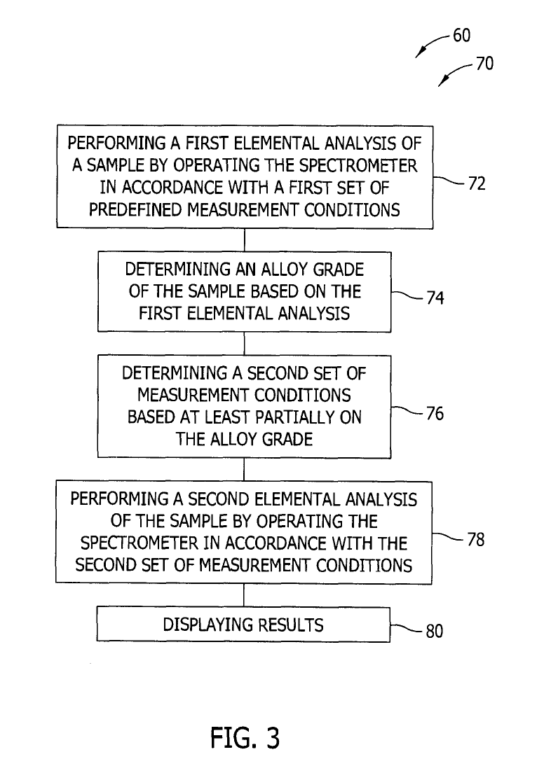

FIG. 3 is a flow chart 60 of an exemplary method 70 for determining measurement conditions to be applied by a detection system, for example, spectrometer 10 (shown in FIG. 1). In the exemplary embodiment, method 70 includes performing 72 a first elemental analysis of a sample, for example, sample 32 (shown in FIG. 1), using a first set of predefined measurement conditions. For example, processing device 20 may access predefined measurement conditions stored within memory device 22 and operate spectrometer 10 accordingly. In the exemplary embodiment, method 70 also includes determining 74 an alloy grade of sample 32 based on the first elemental analysis. The first elemental analysis provides an initial determination of the alloy grade of sample 32. For example, processing device 20 may determine an elemental composition of sample 32 based on secondary radiation 38 detected by detector 14 and determine an alloy grade of sample 32 by comparing the elemental composition to alloy grades stored in memory device 22.

In the exemplary embodiment, method 70 also includes determining 76 a second set of measurement conditions based at least partially on the alloy grade. For example, measurement conditions may be determined that adequately distinguish between the plurality of alloy grades stored within memory device 22 (i.e., determine the alloy grade of a sample beyond a predefined level of certainty) and memory device 22 may store a set of measurement conditions for each of the stored alloy grades.

In the exemplary embodiment, method 70 also includes performing 78 a second elemental analysis of sample 32 using the second set of measurement conditions to determine the alloy grade of sample 32 to a predefined level of certainty. Performing 78 the second elemental analysis may include applying a first predefined level of voltage to a radiation source, for example, radiation source 12 (shown in FIG. 1), for a first predefined length of time. Moreover, performing 78 the second elemental analysis may include applying, after the first predefined length of time, a second predefined level of voltage to the radiation source for a second predefined length of time.

Method 70 may also include displaying 80 results of the second elemental analysis to an operator of spectrometer 10. For example, processing device 20 may provide data to an output device, for example, display 24 (shown in FIG. 1), which provides the data to the operator visually and/or aurally. More specifically, display 24 provides at least one of an energy spectrum and a result of the second elemental analysis of sample 32 to the operator.

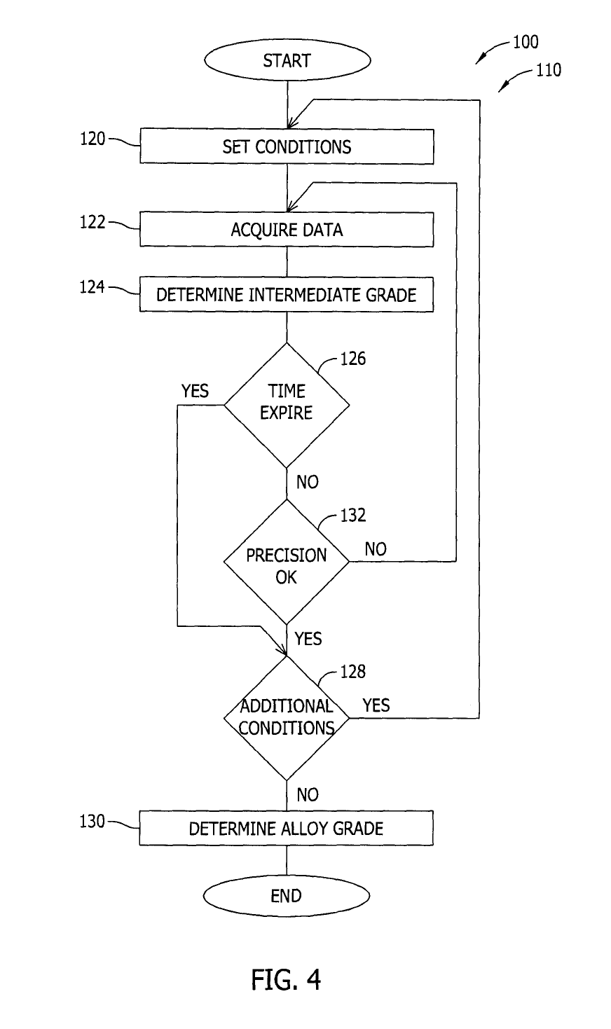

FIG. 4 is a flow chart 100 of an exemplary method 110 for performing an elemental analysis using a detection system, for example, spectrometer 10 (shown in FIG. 1). In the exemplary embodiment, method 110 includes performing 120 a first elemental analysis by applying a first set of predefined measurement conditions to operation of spectrometer 10. Method 110 also includes acquiring 122 data, for example, from detector 14. More specifically, the data acquired is representative of secondary radiation 38 impinged upon detector 14 and used to determine elements included within sample 32. Method 110 also includes determining 124 an intermediate grade identification of sample 32.

In the exemplary embodiment, processing device 20 determines 126 if a measurement duration condition has expired. If the duration condition has expired (i.e., power was provided to radiation source 12 for a predefined length of time), processing device 20 determines 128 if additional measurement conditions are needed to identify the alloy grade of sample 32 to a predefined level of certainty. As described above, measurement conditions associated with alloy grades are predefined and stored for use by spectrometer 10. If, based on the intermediate grade identification of sample 32, additional measurement conditions are needed to identify the alloy grade of sample 32 to the predefined level of certainty, a second elemental analysis is performed 120 by applying the additional measurement conditions to operation of spectrometer 10.

If after a second duration condition has expired, processing device 20 again determines 128 if additional measurement conditions are needed to identify the alloy grade of sample 32 to the predefined level of certainty. If additional measurement conditions are needed, a third elemental analysis is performed 120 by applying the additional measurement conditions to operation of spectrometer 10. This process may repeat as many times as is necessary to achieve the predefined level of certainty as to the alloy grade of sample 32.

In the exemplary embodiment, method 110 also includes determining 130 a final alloy grade of sample 32. For example, once at least the first elemental analysis is completed, and potentially a second elemental analysis, a third elemental analysis etc., and processing device 20 determines 128 that no additional measurement conditions are needed to identify the alloy grade of sample 32 to the predefined level of certainty, processing device 20 determines 130 the final alloy grade of sample 32.

In at least some embodiments, method 110 may also include determining 130 if a precision of the intermediate grade identification is above a predefined precision threshold. For example, processing device 20 may determine an error level associated with each element identified within sample 32. If the error level is below a predefined error level threshold, the precision of the intermediate grade identification is above the predefined precision threshold. If the precision is acceptable (e.g., the error level is lower than the predefined maximum error level threshold), processing device 20 determines 128 if additional measurement conditions are needed to identify the alloy grade to the predefined level of certainty. If the precision is not acceptable, processing device 20 continues acquiring 122 data.

Table 1 is an example of alloy grade information stored within memory device 22. The alloy grade information includes the elemental composition (i.e., a range of weight percentages of a plurality of elements) associated with stored alloy grades. As described above, in the exemplary embodiment, memory device 22 also stores measurement conditions that allow spectrometer 10 to determine the alloy grade of a sample beyond a predefined level of certainty. In the example shown in Table 1, the measurement conditions include a time conditions, voltage conditions, and precision conditions. As described above, the time condition dictates a length of time the spectrometer will expose the sample to the primary beam of radiation. The voltage condition is a voltage level to apply to the radiation generator and the current condition is a current level to apply to the radiation generator. The precision condition includes a predefined error level. When the spectrometer determines an error level is below the predefined error level, the precision of the alloy grade is acceptable. Moreover, the measurement conditions associated with some alloy grades include a first set of measurement conditions and a second set of measurement conditions.

TABLE 1

| | 303/4SS | 321SS | IN 625 |
|---|---|---|---|
| Time Condition I | 5 | 5 | 3 |
| (seconds) | | | |
| Voltage Condition I (kV) | 40 | 40 | 40 |
| Current Condition I | 10 | 10 | 5 |
| (milliamp) | | | |
| Precision Condition I | 5% | 1% | 1% |
| Time Condition II | 5 | 0 | 0 |
| (seconds) | | | |
| Voltage Condition II | 15 | N/A | N/A |
| (kV) | | | |
| Current Condition II | 30 | N/A | N/A |
| (milliamp) | | | |
| Precision Condition II | 1% | N/A | N/A |
| Sub-Table | 1 | 0 | 0 |
| Ti | 0 | 0.2-0.5 | 0-0.4 |
| Cr | 17-20 | 17-19 | 20-30 |
| Mn | 0-2 | 0-2 | 0-0.5 |
| Fe | Balance | Balance | 0-5 |
| Ni | 8-10.5 | 9-12 | Balance |

In the example shown in Table 1, if processing device 20 initially determines, based on the first elemental analysis, that the elemental composition of sample 32 corresponds to alloy grade 625 (i.e., an intermediate grade identification of sample 32 is that sample 32 is a nickel-chromium alloy), processing device 20 applies the measurement conditions associated with alloy grade 625 (included in Table 1) to operation of spectrometer 10. More specifically, to perform the second elemental analysis, processing device 20 applies a first level of voltage (e.g., 40 kV) at a first level of current (e.g., 5 milliamp) to radiation generator 12 for a first length of time (e.g., 3 seconds). If the result of the second elemental analysis is alloy grade 625, the operator knows, to the predefined level of certainty, that sample 32 is composed of alloy grade 625.

Furthermore, in the example shown in Table 1, if processing device 20 makes an initial determination that sample 32 is alloy grade 321, processing device 20 applies the measurement conditions associated with alloy grade 321 (included in Table 1) to operation of spectrometer 10. More specifically, to perform the second elemental analysis, processing device 20 applies the first level of voltage (e.g., 40 kV) at the first level of current (e.g., 10 milliamp) to radiation generator 12 for a first length of time (e.g., 5 seconds). If the result of the second elemental analysis is alloy grade 321, the operator knows, to the predefined level of certainty, that sample 32 is composed of alloy grade 321.

Moreover, in the example shown in Table 1, if processing device 20 makes an initial determination that sample 32 is either alloy grade 303 or alloy grade 304 (i.e., the intermediate grade identification is that sample 32 is either alloy grade 303 or alloy grade 304), processing device 20 applies the measurement conditions associated with alloy grades 303/304 to operation of spectrometer 10. As shown in Table 1, the measurement conditions associated with alloy grades 303/304 include a first set of measurement conditions and a second set of measurement conditions. More specifically, to perform the second elemental analysis, processing device 20 applies the first set of measurement conditions, that is, processing device 20 applies the first level of voltage (e.g., 40 kV) at the first level of current (e.g., 10 milliamp) to radiation generator 12 for the first length of time (e.g., 5 seconds). Furthermore, processing device 20 then applies the second set of measurement conditions, that is, processing device 20 applies a second level of voltage (e.g., 15 kV) at a second level of current (e.g., 30 milliamp) to radiation generator 12 for a second length of time (e.g., 5 seconds). The elemental composition results of the second elemental analysis are compared to elemental composition ranges included in Table 2. Table 2 is a sub-table used to differentiate between alloy grade 303 and alloy grade 304. The amount of sulfur (S) differentiates alloy grade 303 from alloy grade 304. The lower voltage level aids in identifying sulfur, which has a lower emission energy than the other elements (i.e., titanium, chromium, manganese, iron, and nickel).

TABLE 2

| | 303 | 304 |
|---|---|---|
| S | 0.1-0.3 | 0-0.05 |
| Ti | 0 | 0 |
| Cr | 17-19 | 18-20 |
| Mn | 0-2 | 0-2 |
| Fe | Balance | Balance |
| Ni | 8-10.5 | 8-10.5 |

Described herein are exemplary methods and systems for performing an X-ray fluorescence analysis of a sample. More specifically, the methods and systems described herein automatically determine measurement conditions that will result in the determination of an alloy grade of a sample to a predefined level of certainty. A spectrometer is configured to perform a first elemental analysis of the sample and an initial determination is made as to the elemental composition of the sample. From the elemental composition an intermediate determination of the alloy grade is determined. Stored measurement conditions corresponding to the alloy grade are accessed and applied to operation of the spectrometer to perform a second elemental analysis of the sample. The results of the second elemental analysis provide an operator of the spectrometer with the alloy grade of the sample, to a predefined level of certainty.

The methods and systems described herein facilitate efficient and economical X-ray fluorescence testing. Exemplary embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

When introducing elements/components/etc. of the methods and systems described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and 19111-107 performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A spectrometer for determining a composition of a sample, said spectrometer comprising:
a radiation source configured to generate a primary beam of radiation to be directed toward the sample;
a detector configured to generate a detector signal representative of a secondary beam of radiation from the sample after being impinged by the primary beam of radiation; and
a processing device coupled to said radiation source and said detector, said processing device configured to:
control operation of said spectrometer in connection with performing a first elemental analysis of the sample;
determine an alloy grade of the sample based on the detector signal generated in connection with the first elemental analysis; and
determine at least one measurement condition based at least partially on the alloy grade.

2. A spectrometer in accordance with claim 1, wherein said processing device is configured to control operation of said spectrometer in accordance with at least one predefined measurement condition to perform the first elemental analysis of the sample.

3. A spectrometer in accordance with claim 2 further comprising a plurality of filters, and wherein the at least one predefined measurement condition comprises at least one of a level of voltage to apply to said radiation source, a level of current to apply to said radiation source, and a filter of the plurality of filters to apply during the first elemental analysis.

4. A spectrometer in accordance with claim 2, wherein the at least one predefined measurement condition comprises a length of time power is applied to said radiation source.

5. A spectrometer in accordance with claim 2 further comprising a memory device coupled to said processing device, and wherein the at least one predefined measurement condition is stored within said memory device.

6. A spectrometer in accordance with claim 5, wherein said memory device is further configured to store a plurality of alloy grades and at least one measurement condition associated with each of the plurality of alloy grades, wherein the at least one measurement condition associated with each of the plurality of alloy grades, when applied to operation of the spectrometer, provides an operator of the spectrometer with the alloy grade of the sample, to a predefined level of certainty.

7. A spectrometer in accordance with claim 1, wherein said processing device is further configured to control operation of said spectrometer in connection with performing a second elemental analysis of the sample by operating in accordance with the at least one measurement condition determined based on the alloy grade.

8. A spectrometer in accordance with claim 7, wherein the at least one measurement condition determined based on the alloy grade comprises at least one of a level of voltage to apply to said radiation source, a level of current to apply to said radiation source, a length of time power is applied to said radiation source, and a filter of the plurality of filters to apply during the second elemental analysis.

9. A spectrometer in accordance with claim 1 further comprising an output device communicatively coupled to said processing device and configured to display at least one of an energy spectrum and a result of the elemental analysis of the sample.

10. A method for determining measurement conditions to be applied by a spectrometer, said method comprising:
performing a first elemental analysis of a sample by operating the spectrometer in accordance with a first set of predefined measurement conditions;
determining an alloy grade of the sample based on the first elemental analysis; and
determining a second set of measurement conditions based at least partially on the alloy grade.

11. A method in accordance with claim 10, further comprising storing, in a memory device, the first set of predefined measurement conditions, wherein the first set of measurement conditions, when applied to operation of the spectrometer, provide an intermediate determination of the alloy grade of the sample.

12. A method in accordance with claim 11, further comprising storing, in the memory device, at least one measurement condition associated with each of a plurality of alloy grades, and wherein determining the second set of measurement conditions comprises accessing the stored measurement conditions within the memory device.

13. A method in accordance with claim 12, further comprising predefining measurement conditions adequate to distinguish between the plurality of alloy grades stored in the memory device.

14. A method in accordance with claim 10, further comprising performing a second elemental analysis of the sample by operating the spectrometer in accordance with the second set of measurement conditions.

15. A method in accordance with claim 14, further comprising displaying, using an output device, at least one of an energy spectrum and a result of the second elemental analysis of the sample.

16. A method in accordance with claim 14, wherein performing the second elemental analysis comprises at least one of applying a first predefined level of voltage to a radiation source associated with the spectrometer, applying a first predefined level of current to the radiation source, operating the radiation source for a first predefined length of time, and applying a predefined filter to a primary beam of radiation.

17. A method in accordance with claim 16, wherein performing the second elemental analysis comprises applying, after the first predefined length of time, at least one of a second predefined level of voltage and a second predefined level of current to the radiation source for a second predefined length of time.

18. A control system for use with a spectrometer, said control system comprising:
a memory device configured to store a plurality of measurement conditions; and
a processing device coupled to said memory device and configured to:
control operation of said spectrometer, in accordance with a first measurement condition of the plurality of measurement conditions, to perform a first elemental analysis of a sample;
determine an alloy grade of the sample based on the first elemental analysis of the sample;
determine a second measurement condition of the plurality of measurement conditions that is associated with the alloy grade; and
control operation of said spectrometer, in accordance with the second measurement condition, to perform a second elemental analysis of the sample.

19. A control system in accordance with claim 18, wherein the plurality of measurement conditions comprise at least one of a length of time the measurement is taken, a level of voltage applied to a radiation source included within said spectrometer, a level of current applied to the radiation source, and a filter to apply to an output of the radiation source.

20. A control system in accordance with claim 18, wherein the first measurement condition comprises at least one predefined measurement condition corresponding to an intermediate determination of the alloy grade of the sample.

21. A control system in accordance with claim 18, wherein the second measurement condition, when applied to operation of said spectrometer, provides an operator of said spectrometer with the alloy grade of the sample, to a predefined level of certainty.

22. A method for configuring a spectrometer to determine an alloy grade of a sample, wherein the spectrometer comprises a radiation source, a detector, and a memory device, each communicatively coupled to a processing device, said method comprising:
storing, in the memory device, alloy grade information for each of a plurality of alloy grades;
storing, in the memory device, at least one measurement condition associated with each of the plurality of alloy grades;
configuring the processing device to operate the spectrometer in accordance with a first measurement condition to perform a first elemental analysis of a sample;
configuring the processing device to determine an alloy grade of the sample based on the first elemental analysis and the stored alloy grade information;
configuring the processing device to determine a second measurement condition based at least partially on the alloy grade; and
configuring the processing device to operate the spectrometer in accordance with the second measurement condition to perform a second elemental analysis of the sample.

23. A method in accordance with claim 22, wherein configuring the processing device to determine the second measurement condition comprises configuring the processing device to access the stored at least one measurement condition within the memory device.

24. A method in accordance with claim 23, further comprising predefining measurement conditions adequate to distinguish between the plurality of alloy grades stored within the memory device.

25. A method in accordance with claim 22, further comprising configuring an output device to display at least one of an energy spectrum and a result of the second elemental analysis of the sample.

26. A method in accordance with claim 22, wherein configuring the processing device to operate the spectrometer in accordance with the second measurement condition comprises configuring the processing device to facilitate application of at least one of a first predefined level of voltage and a first predefined level of current to the radiation source for a first predefined length of time.

27. A method in accordance with claim 26, wherein configuring the processing device to operate the spectrometer in accordance with the second measurement condition comprises configuring the processing device to facilitate application of at least one of a second predefined level of voltage and a second predefined level of current to the radiation source, after the first predefined length of time, for a second predefined length of time.
